(19) United States
(12) Patent Application Publication
(10) Pub. No.: US 2005/0249208 A1
(43) Pub. Date: Nov. 10, 2005

(54) Network system in which public IP addresses are unnecessary, and the system setting method

(75) Inventor: Woo-Chang Kim, Suwon-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/090,687

(22) Filed: Mar. 28, 2005

(30) Foreign Application Priority Data
May 4, 2004 (KR) 2004-31230

(51) Int. Cl. H04L 12/56

(52) U.S. Cl. 370/389

(57) ABSTRACT

Disclosed is a network system and a method for using an IGMP snooping function and an IGMP proxy function to perform communications between a device using a private IP address and a server using a public IP address. To that end, a host having the public IP address transfers data of the device to the server having the public IP address. The server uses the IGMP snooping function and a multicast address of the device, including the received data, to transfer the data to a corresponding device. In addition, the device transfers an IGMP report packet with respect to an IGMP query-packet to transfer information about whether the device is normal, and the server transfers the information to the host when the device is abnormal.

### CROSS-REFERENCE TO RELATED APPLICATIONS

This application claims benefit under 35 U.S.C. § 119(a) to an application entitled “The Network System Whose Public IP Address is Unnecessary, and the System Setting Method”, filed in the Korean Intellectual Property Office on May 4, 2004, and assigned Korean Patent Application No. 2004-31230, the entire contents of which are expressly incorporated herein by reference.

### BACKGROUND OF THE INVENTION

1. Field of the Invention

The present invention relates to a network system using a public internet protocol (IP). More particularly, the present invention relates to a network system for preventing a shortage of limited IP addresses and a method for designing the network system

2. Description of the Related Art

In general, IP addresses used on the network are classified into private IP addresses and public IP addresses. Private IP addresses are ones that cannot be identified on the Internet and can be used only within the network. The private IP addresses are generally used in a home local area network (HLAN) or in a company. An advantage of using private IP addresses results from the fact that it is useful to allocate addresses using the private network in order to efficiently use the limited IP addresses. An Internet Assigned Numbers Authority (IANA) for managing whole IP addresses has already secured private IP addresses for the private network. A plurality of private IP addresses randomly used in the network are converted into public IP addresses in a network address translation (NAT) when they are required to establish a communication with an external network. One IP address may be overlapped over several networks because the private IP addresses are used only within the private network so that they do not collide with public IP addresses outside the network.

One public IP address indicates a unique address on the Internet. The public IP address is allocated to a corresponding authority of each country, and one public IP address is allocated to a server for the HLAN.

A shortage of public IP addresses is rapidly approaching, however, due to network activation and supply of host computers. Generally, devices and host computers constituting a network employ the public IP address to use a Transmission Control Protocol/Internet Protocol (TCP/IP). The number of public IP addresses available in the network system is limited, however, so that the shortage of public IP addresses becomes serious when the number of devices and host computers connected to the network system increases.

To deal with the above-mentioned problem, a private IP address may be utilized that is only used in a constant local network. This private IP address has a disadvantage, however, in that it should be used only in the local network. Accordingly, plans for preventing the shortage of limited public IP addresses are under discussion.

### SUMMARY OF THE INVENTION

An object of the present invention is to substantially solve at least the above problems and/or disadvantages and to provide at least the advantages described below. Accordingly, it is an object of the present invention to provide a system and a method for efficiently using the limited public IP addresses on the network.

It is another object of the present invention to provide a system and a method for efficiently using the limited public IP addresses by means of the public IP address and the private IP address.

It is still another object of the present invention to provide a system and a method for allowing users trying to access the Internet to use a device without allocating the public IP address to the device connected to a server.

According to one aspect of the present invention, there is provided a method for transporting a packet from a host to a device in a network system including at least the host for receiving and using an allocated public Internet Protocol (IP) address, and at least the device for receiving the packet from the host, and receiving and using an allocated multicast address, wherein the method comprises allowing the host to transfer the packet including the multicast address to a switch through a server, and transferring the packet to the device for receiving and using the allocated multicast address constituting the received packet.

According to another aspect of the present invention, there is provided a method for allowing a server to transfer a packet received from a host in a system network including at least the host for receiving and using an allocated public Internet Protocol (IP) address, and at least the device for receiving the packet from the host, and receiving and using an allocated broadcast address, wherein the method comprises determining a state of the device for using the multicast address constituting the packet when the server for receiving and using the allocated public IP address receives the packet, and transferring the packet only when the state of the device is determined to be normal.

According to another aspect of the present invention, there is provided a method for allowing a device to receive a packet in a system network including at least a host for receiving and using an allocated public Internet Protocol (IP) address, and at least the device for receiving the packet from the host, and receiving and using an allocated multicast address, wherein the method comprises transferring a report packet including the multicast address to request a subscription to the network system, and receiving, from the switch, only the packet having the same multicast address as that the device is using.

According to still another aspect of the present invention, there is provided a network system including at least a host for receiving and using an allocated public Internet Protocol (IP) address, and at least a device for receiving a packet from the host and receiving and using an allocated multicast address when the packet is transferred from the host to the device, wherein the network system comprises at least the host for generating and transferring the packet including the multicast address, a server for transferring the packet transferred from the host and using the allocated public IP address, a switch for transferring the packet to a device using the same multicast address as that included in the packet transferred from the server; and at least the device.

### BRIEF DESCRIPTION OF THE DRAWINGS

The above aspects and features of the present invention will be more apparent by describing certain embodiments of the present invention with reference to the accompanying drawings, in which:

FIG. 1 illustrates a network system that includes a server, a switch, and a plurality of groups, each group including at least one device, according to an embodiment of the present invention;

FIG. 2 illustrates a network system that includes a plurality of hosts, a server, a switch, and a plurality of groups, each group including at least one device, according to an embodiment of the present invention;

FIG. 3 is a diagram illustrating a packet structure generated in the host in accordance with an embodiment of the present invention;

FIG. 4 is a flow diagram illustrating a method for operating a host in accordance with an embodiment of the present invention;

FIG. 5 is a flow diagram illustrating a method for operating a server to manage a device management table in accordance with an embodiment of the present invention;

FIG. 6 is flow diagram illustrating another method for operating a server that has received a packet in accordance with an embodiment of the present invention; and

FIG. 7 is a flow diagram illustrating a method for operating a device in accordance with an embodiment of the present invention.

### DETAILED DESCRIPTION OF EXEMPLARY EMBODIMENTS

Several embodiments of the present invention will now be described in detail with reference to the annexed drawings. In the drawings, the same or similar elements are denoted by the same reference numerals even though they are depicted in different drawings. In the following description, a detailed description of known functions and configurations incorporated herein have been omitted for conciseness and clarity.

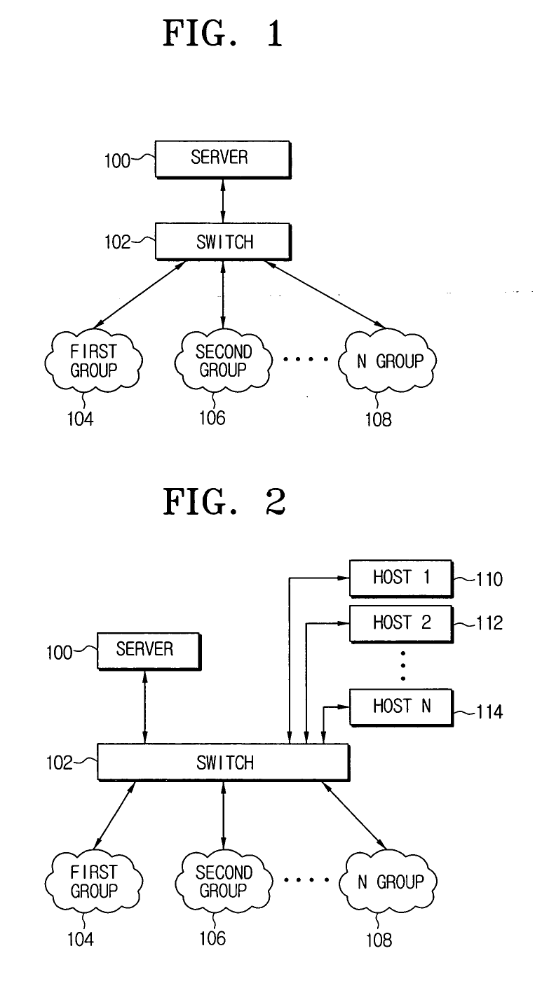

FIG. 1 shows N groups 104 to 108, each comprised of at least one device connected to at least one server 100 in accordance with an embodiment of the present invention. The N groups 104 to 108 and the server 100 are connected to a switch 102. Hereinafter, a configuration of FIG. 1 will be described in detail.

The server 100 uses a public IP address and carries out a function of transferring one or more packets, as required by the device. As mentioned above, the device is included in at least one group. FIG. 1 shows the first group 104 to Nth group 108. By way of example, the Table I below shows devices included in each group.

TABLE I

| Group | Device |
|---|---|
| First group | Device 1, device 2 |
| Second group | Device 3 |
| . . . | . . . |
| Nₜₕ group | Device M |

As discussed above, each group is comprised of at least one device. Devices constituting each group use the same multicast address. Hereinafter, a public address mapping of IP version 4 (Ipv4) will be described. The IPv4 public address mapping is classified into 5 classes based on the number of hosts to be included to a network in use.

Class A is mainly used in a large scale network having many hosts, Class B is mainly used in a medium scale network, Class C is mainly used in a small scale network, and Class D is used for a multicast. In general, Class D is used for a private IP address. Hereinafter, an address included in the Class D is referred to as a multicast address or a private IP address. Class E is reserved for experimental uses.

Table II below shows addresses allocated per each class.

TABLE II

| Class | Start address | Last address |
|---|---|---|
| Class A | 1.x. x. x | 126.x.x. x |
| Class B | 128.1.x. x | 191.254.x. x |
| Class C | 192.0.1.x | 223.225.254.x |
| Class D | 224.0.0.0 | 239.255.255.255 |
| Class E | | |

The switch 102 carries out two functions. One is to carry out an internet group management protocol (IGMP) snooping function and the other is to carry out an IGMP proxy function.

The IGMP snooping function transfers packets from the server 100 only to a group having a specific multicast address. When the device transfers a packet to the server 100 through the private IP address, the server 100 cannot identify the transferred packet due to a difference between the IP address that the server is using and the IP address constituting the transferred packet, so that the packet is discarded. The problem occurs from the fact that the server 100 uses a public IP address and the device uses a private IP address. The IGMP proxy function is to exchange the source address included in the packet transferred by the device with the address of the switch 102. A public IP address is generally used for the address of the switch 102. Since the switch 102 carries out the IGMP proxy function, the packet may be transceived between the device using the private IP address and the server 100 using the public IP address.

FIG. 2 shows hosts 110 to 114 connected to the Internet, a server 100, and devices included in each group in accordance with an embodiment of the present invention. These components are connected to the switch 102. Hereinafter, functions of devices using the private IP addresses and hosts using the public IP addresses will be described with reference to FIG. 2.

The first host 110 to Nₜₕ host 114 are connected to the Internet, and use public IP addresses. The hosts 110 to 114 transfer packets, which have been transferred to the devices, to the server 100 through the switch 102. The packets transferred to the devices by the hosts 110 to 114 can be printing data, and other functions.

FIG. 3 shows a packet that is transferred to the server 100 by the hosts 110 to 114. The packet is comprised of a header section and a data section. The header section includes a source address, a destination address, and a packet type. The source addresses means the host address, and the destination address means the server address to which the packet is transferred.

The data section is comprised of a multicast address and data. The multicast address indicates an address of a group to which the packet is transferred by the host. The switch 102 transfers the packet to the server 100 by means of the destination address included in the packet. In this case, the hosts 110 to 114 and the server 100 use public IP addresses, so that the switch 102 does not need to carry out the IGMP proxy function.

The server 100 converts the received packet into a multicast packet, and transfers the converted packet to the switch 102. The switch 102 transfers the packet to a corresponding group by means of the multicast address included in the received multicast packet and the IGMP snooping function. Table III below shows private IP addresses allocated to respective groups by way of example.

Table III

| Group | Allocated Address |
|---|---|
| First group | 224.125.125.125 |
| Second group | 226.254.254.255 |
| . . . | . . . |
| Nₜₕ group | 239.255.255.255 |

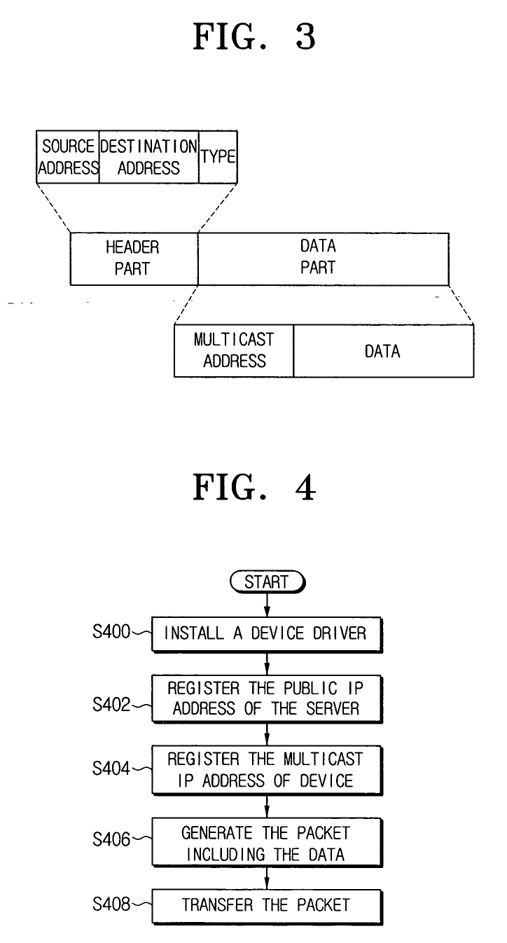

Hereinafter, operations carried out in respective components in accordance with an embodiment of the present invention will be described with reference to FIGS. 4 to 7.

FIG. 4 shows operations carried out in the host in accordance with an embodiment of the present invention. Hereinafter, operations carried out in the host will be described in detail with reference to FIG. 4.

In a step S400, the host installs a device driver with respect to each device. In a step S402, the host registers the public IP address of the server. The host transfers the generated packet to the server using the public IP address of the registered server.

In a step S404, the host registers the multicast IP address with respect to each group. In addition, it stores information about the device included in each group. The information about the device included in each group is represented in Table I, and the multicast address with respect to each group is represented in the Table III.

In a step S406, when data are generated and transferred to the device, the host generates the packet including the data. The packet generated in the host is shown as Table III. The host generates the packet including the source address, the destination address, and the multicast address. The generated packet is transferred to the switch in a step S408.

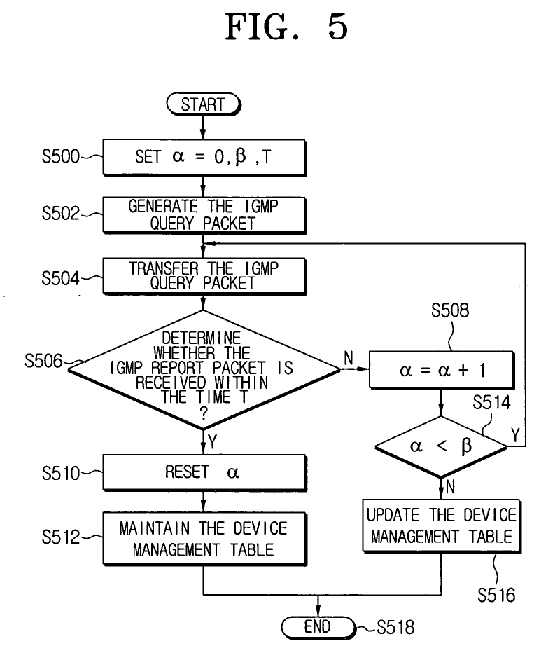

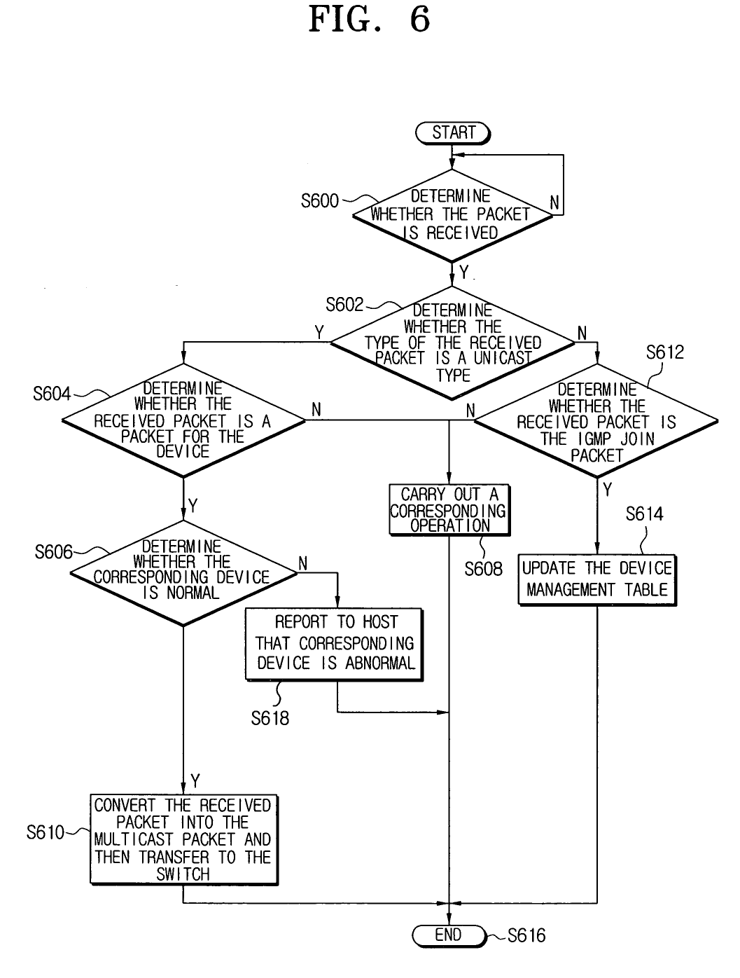

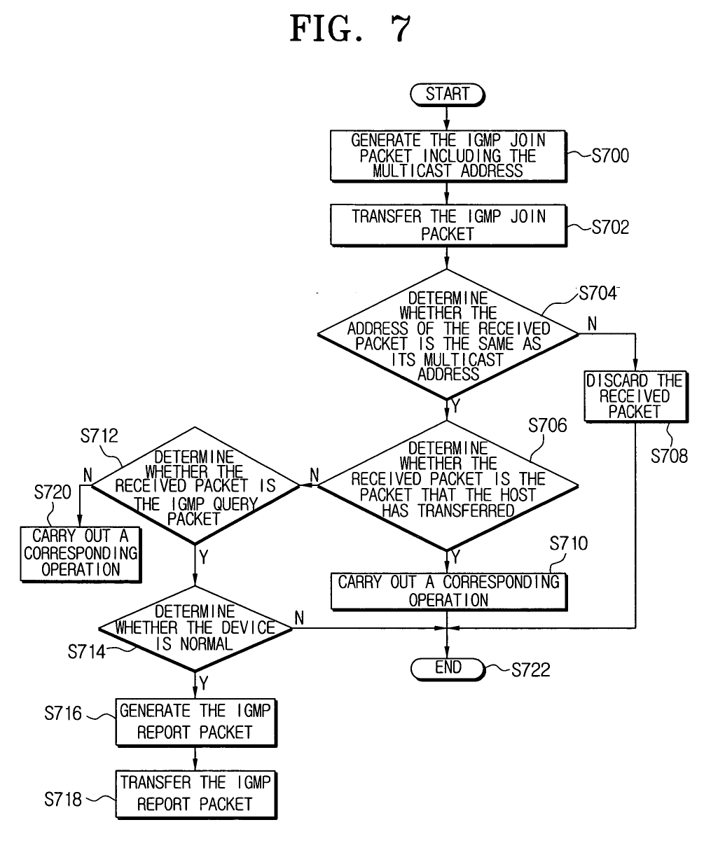

FIGS. 5 and 6 show operations carried out in the server in accordance with an embodiment of the present invention. FIG. 5 shows how the server manages a device management table, and FIG. 6 shows how the received packet is transferred.

Referring to FIG. 5, step S500, the server sets the variables α, β, and T. The variable α is the number of transfer attempts for a unique IGMP query packet, and β is the maximum number of transfer attempts for the unique IGMP query packet. Initially, α is set to 0, and β is set to some predetermined number. T is a time for retransferring the IGMP query packet. In step S502, the server generates the IGMP query packet. The server determines the state of the device by means of the IGMP query packet. In step S504, the server transfers the generated IGMP query packet.

In decision step S506, the server determines whether the IGMP report packet is received within the time T. When the IGMP report packet is not received within the time T (“No” path from decision step S506), the server 100 continues to step S508, and when the IGMP report packet is received within the time T (“Yes” path from decision step S506), the server continues to step S510.

In step S508, the server increases α by 1, and the process continues to step S514. In decision step S514, the server determines whether α is greater or smaller than β. If α is smaller than β (“Yes” path from decision step S514), the server goes back to step S504, and when α is not smaller than β “No” path from decision step S514), the server continues to step S516. In step S516, the server updates the device management table so as to display the state of the corresponding device to be abnormal. The server determines that the state of the corresponding device to be abnormal when the number of attempts to transfer a unique IGMP query packets exceeds the predetermined number β.

If the server 100 determines that the IGMP has been received in the allotted amount of time T (“Yes” path from decision step S506), the server 100 resets α, and the process continues to step S512 to maintain the device management table. Table IV below shows one example of the device management table under control of the server 100.

TABLE IV

| Multicast address | State |
|---|---|
| 224.125.125.125 | Normal |
| 226.254.254.255 | Normal |
| . . . | . . . |
| 239.255.255.255 | Abnormal |

As mentioned above, devices constituting each group use one multicast address, so that the state of the corresponding group including the devices is abnormal when any one of the devices included in each group is abnormal. To deal with this problem, a scheme for including only one device in one group is presented.

The server can set transfer periods of the IGMP query packet different from one another to be transferred to each group. The transfer period of the IGMP query packet can be individually set based on the number of devices included in each group. When the transfer period of the IGMP query packet is different from one another for each group, the server generates the IMGP query packet according to group, and transfers the generated IGMP query packet to each group. For example, the transfer period of the IGMP query packet can be set as a 1T for a first group and 2T for a second group and so on.

When the transfer periods of the IGMP query packet to be transferred to each group are set to be the same, however, the generated IGMP query packet can be transferred to all groups constituting the network. As a result, the server can reduce its load.

FIG. 6 is a flow diagram illustrating a method for operating the server 100 that has received the packet in accordance with an embodiment of the present invention. In decision step S600, the server 100 determines whether the packet is received. The method continues to decision step S602 when the server receives the packet.

In decision step S602, the server 100 determines whether the type of the received packet is a unicast type. As discussed above, the host transfers the packet to the server 100 in a unicast manner. Therefore, the host identifies the public IP address of the server 100, so that it transfers the packet to the server 100 through the switch in a unicast manner. When the type of the received packet is the unicast type (“Yes” path from decision step S602), the server continues to decision step S604. If, however, the type of received packet is a multicast type, the server 100 continues to decision step S612.

In decision step S604, the server 100 determines whether the received packet is a packet for the device. The server continues to decision step S606 when the received packet is the packet for the device, and continues to step S608 when the received packet is not the packet for the device (“No” path from decision step S604). In step S608, the server 100 carries out a corresponding operation based on the information included in the received packet.

In decision step S606, the server determines whether the corresponding device (corresponding group) is normal. The determination is made by means of the device management table. The server 100 continues to step S610 when the corresponding device is normal, (“Yes path from decision step S606) and continues to a step S615 when the corresponding device is abnormal (“No path from decision step S606). The server 100 reports to the host that the corresponding device is abnormal in step S615, and terminates the method in step S616. In step S610, the received packet is converted into the multicast packet and then transferred to the switch 102. A description on the procedure of converting the received packet into the multicast packet is omitted since it is well known to those of ordinary skill in the art.

The method then proceeds to decision step S612 from decision step S602 if it is determined that the type of received packet is not a unicast type (that is, it is a multicast type) (“No” path from decision step S602). In decision step S612, the server determines whether the received packet is the IGMP join packet. The server 100 continues to step S614 when the received packet is the IGMP join packet (“Yes” path from decision step S612), and continues to step S608 to carry out a corresponding operation when the received packet is not the IGMP join packet (“No” path from decision step S612). In step S614, the server 100 updates the device management table. The server 100 updates the device management table by adding the information with respect to the device that has transferred the IGMP join packet.

FIG. 7 is a flow diagram illustrating a method for operating the device in accordance with the present invention. In step S700, the device generates an IGMP join packet including the multicast address. As devices, join the group for a first time, they generate the IGMP join packet. In decision step S702, the device transfers the generated IGMP join packet.

In decision step S704, the device receives the packet, and determines whether the address of the received packet is the same as its multicast address. The device continues to decision step S706 if the address of the received packet is the same as its multicast address (“Yes” path from decision step S706), and continues to step S708 to discard the received packet if the address of the received packet is not the same as its multicast address (“No” path from decision-step S704). In general, the switch 102 carries out the IGMP snooping function, so that the device receives the multicast packet having the same address as the address of the device.

In decision step S706, the device determines whether the received packet is the packet that the host has transferred. The device continues to step S710 if the packet is the one transferred by the host (“Yes” path from decision step S706). The device continues to decision step S712 when the packet is transferred by the server upon determination. In step S710, the device uses data included in the packet transferred by the host to carry out a corresponding operation. For example, the device carries out a printing operation when data included in the packet transferred by the host is printing data.

In decision step S712, the device determines whether the received packet is the IGMP query packet. The device continues to decision step S714 if the received packet is the IGMP query packet (“Yes” path from decision step S712), and continues to step S720 if the received packet is not the IGMP query packet (“No” path from decision step S712). In step S720, the device uses data included in the received packet to carry out a corresponding operation.

In decision step S714, the device determines whether the device is normal. The device continues to step S716 if the device is normal (“Yes” path from decision step S714), and continues to step S722 when it is not normal (“No” path from decision step S714). In step S716, the device generates an IGMP report packet. The IGMP report packet generated in the step S700 is different from that generated in the step S716. The IGMP report packet generated in the step S700 is one generated by the device that joins the network for the first time, and the IGMP report packet generated in the step S716 is a packet in response to the IGMP query packet.

In step S718, the device transfers the IGMP report packet generated in step S716 to the switch 102. The switch 102 performs the IGMP proxy operation on the received IGMP report packet and transfers it to the server 100.

As discussed above, the exemplary embodiments of the present invention use the IGMP snooping function and the IGMP proxy function to establish communication between the device using the private IP address and the server using the public IP address, which allows limited public IP addresses to be efficiently used.

The foregoing embodiment and advantages are merely exemplary and are not to be construed as limiting the present invention. The present teaching can be readily applied to other types of apparatuses. Also, the description of the embodiments of the present invention is intended to be illustrative, and not to limit the scope of the claims, and many alternatives, modifications, and variations will be apparent to those skilled in the art.

1. A method for transporting a packet from a host to a device in a network system including at least the host for receiving and using an allocated public Internet Protocol (IP) address, and at least the device for receiving the packet from the host, and receiving and using an allocated multicast address, the method comprising:
allowing the host to transfer the packet including the multicast address to a switch through a server; and
transferring the packet to the device for receiving and using the allocated multicast address constituting the received packet.

2. The method as recited in claim 1, further comprising:
unicasting the packet by the host to the server for receiving and using the allocated public IP.

3. The method as recited in claim 2, further comprising:
updating and storing each state by the server with respect to each device in a constant time period.

4. The method as recited in claim 3, further comprising:
identifying the state of the device by the server for using the multicast address included in the transferred packet; and
transferring the packet to the switch only when the state of the device is determined to be normal.

5. A method for allowing a server to transfer a packet received from a host in a system network including at least the host for receiving and using an allocated public Internet Protocol (IP) address, and at least the device for receiving the packet from the host, and receiving and using an allocated broadcast address, the method comprising:
determining a state of the device for using the multicast address constituting the packet when the server for receiving and using the allocated public IP address receives the packet; and
transferring the packet only when the state of the device is determined to be normal.

6. The method as recited in claim 5, further comprising:
transferring a query packet to the device by the server in a constant time period in order to determine the state of each device.

7. The method as recited in claim 6, further comprising:
identifying that the device is abnormal by the server when a report packet that is a response to the query packet is not received from the device.

8. The method as recited in claim 6, further comprising:
transferring the query packet by the switch to only the device for using the multicast address included in the query packet transferred from the server.

9. A method for allowing a device to receive a packet in a system network including at least a host for receiving and using an allocated public Internet Protocol (IP) address, and at least the device for receiving the packet from the host, and receiving and using an allocated multicast address, the method comprising:
transferring a report packet including the multicast address to request a subscription to the network system; and
receiving, from the switch, only the packet having the same multicast address as that the device is using.

10. The method as recited in claim 9, further comprising:
transferring the report packet that is a response to the query packet, when the received packet is the query packet transferred from the server to determine a state of the device

11. The method as recited in claim 9, further comprising:
carrying out a corresponding operation indicated by the packet when the received packet is the packet indicating an operation transferred from the host.

12. A network system including at least a host for receiving and using an allocated public Internet Protocol (IP) address, and at least a device for receiving a packet from the host and receiving and using an allocated multicast address when the packet is transferred from the host to the device, the network system comprising:
at least the host for generating and transferring the packet including the multicast address;
a server for transferring the packet transferred from the host and using the allocated public IP address; and
a switch for transferring the packet to a device using the same multicast address as that included in the packet transferred from the server; and at least the device.

13. The network system as recited in claim 12, wherein the server updates a state of the device in the constant time period, and transfers the packet only when the device using the same multicast address as that constituting the packet transferred from the host is normal.

14. The network system as recited in claim 13, wherein the device that attempts to join the network system transfers a report packet including a multicast address of the device to the server.

15. The network system as recited in claim 13, wherein the server transfers a query packet including a multicast address in a constant time period to determine the state of the device.

16. The network system as recited in claim 15, wherein the server determines that the device is normal only when the report packet that is a response to the query packet is transferred from the device.

17. The network system as recited in claim 15, wherein the device transfers the report packet that is a response to the query packet when the transferred packer is the query packet for determining the state of the device that the server has transferred.

18. The network system as recited in claim 15, wherein the device carries out a corresponding operation that the packet indicates when the transferred packet is the packet for indicating an operation that the host has transferred.
